(19) United States
(12) Patent Application Publication
(10) Pub. No.: US 2015/0214708 A1
(43) Pub. Date: Jul. 30, 2015

(54) Wall-Mounted Charging Device and Modular Outlet Extender

(71) Applicant: Seymour Segnit, Cornwall-on-Hudson, NY (US)

(72) Inventor: Seymour Segnit, Cornwall-on-Hudson, NY (US)

(73) Assignee: Think Charger, Cornwall-on-Hudson, NY (US)

(21) Appl. No.: 14/565,118

(22) Filed: Dec. 9, 2014

Related U.S. Application Data
(60) Provisional application No. 61/913,890, filed on Dec. 9, 2013.

(51) Int. Cl. H02G 3/18; H02G 3/10; H02G 3/08

(52) U.S. Cl. CPC H02G 3/18; H02G 3/081; H02G 3/10

(57) ABSTRACT

The present invention provides a novel wall-mounted charging device and modular outlet extender that may be inserted into a standard wall outlet without additional wires and provides a platform for charging the electrical device without intruding into the user's environment. The extender provides a housing, an electrical outlet, a set of electrical connection prongs, and an auxiliary charging port on the top wall. The top wall supports an electrical device while it is connected to the auxiliary port for charging. The device may also include a removable charging tip in the auxiliary port, a second port formed in the bottom wall, auxiliary ports in the bottom wall, and auxiliary ports in the sidewalls. The device will generally include a power supply providing low voltage power to the auxiliary ports to provide low voltage power to electrical devices for charging. The device may also include a ground fault interrupter, a surge protector a mechanical power interruption switch, a WiFi extender, a thunderbolt connection, a USB connector, a Micro USB connector, an HDMI connector, an Ethernet connector, or any other industry standard connectors, or may include a remote control unit or an audio connector.

### CROSS-REFERENCE TO RELATED APPLICATIONS

The present invention claims priority to U.S. Provisional Application No. 61/913,890, entitled “Apparatus and Method for a Wall-Mounted Auxiliary Charging Device and Outlet Extender” filed Dec. 9, 2013 and listing Seymour Segnit as Inventor. This application claims the benefit of all aspects of U.S. Provisional Application No. 61/913,890 and all aspects of the prior application are hereby incorporated by reference.

### TECHNICAL FIELD AND INDUSTRIAL

### Applicability of the Invention

The present invention relates a wall mounted charger for supporting and charging electronic components such as phones, tablets, readers and other low voltage devices. The present invention typically includes one or more electrical outlets on the front face such that the use of the wall outlet is not lost. The wall adapter of the present invention is suitable for use in any major country and may be adapted to the outlet configuration and voltage of those countries.

### BACKGROUND OF THE INVENTION

Large numbers of charging devices electronic devices are known in the art. Generally, a charging device includes a high frequency transformer to produce a fully isolated and regulated low DC voltage at amperages suitable for charging the electronic component. The power input is generally a residential 120V 60 Hz source in North America and 100-250V at 50-60 Hz outside of North America. Typically, the transformer base portion is plugged into a wall outlet and a cable connects the electronic device to the base.

Often, the transformer base unit is hard wired to the cable and is suitable only for use with a single type of electronic device. Another configuration is that the base unit includes a standardized bus port, such as a Universal Serial Bus Port (USB) or other manufacturer specific port. With the proliferation of mobile phones, e-readers, tablets, notepad computers and other portable electronic devices the storage and sorting of charges has grown to be burdensome. Sorting base units and cables for any number of electronic devices consumes time, storage space, and also space on a wall outlet or on a power strip.

Conventional wall outlets are generally installed to be substantially flush with the surface of the wall. Generally, upper and lower outlets are included on the front face. Often, the base units are configured such that only a single unit may be plugged into an outlet at any one time so that the entire face of the outlet is dedicated to charging a single device.

### SUMMARY OF THE INVENTION

The present invention provides a novel wall-mounted charging device and modular outlet extender that may be inserted into a standard wall outlet without additional wires and provides a platform for charging the electrical device without intruding into the user's environment. The wall-mounted charging device and modular outlet extender provides a housing, at least one electrical outlet, at least one set of electrical connection prongs, and an auxiliary charging port formed on the top wall. The top wall supports an electrical device while it is connected to the auxiliary port for charging. The wall-mounted charging device and modular outlet extender may also include a removable charging tip extending from the auxiliary port, and a second auxiliary port formed in the bottom wall of housing. The device may also include a plurality of auxiliary ports formed in the bottom wall of housing, one or more auxiliary ports formed in the sidewalls of housing. The device will generally also include a power supply unit providing low voltage power to the auxiliary ports so that low voltage power is provided to the electrical device for charging. The device may include other features in the housing such as: a ground fault interrupter, a surge protector a mechanical power interruption switch, a WiFi extender, a thunderbolt connection, a USB connector, a Micro USB connector, an HDMI connector, an Ethernet connector, or any other industry standard connectors, or may include a remote control unit or an audio connector.

### BRIEF DESCRIPTION OF THE DRAWING

A more complete appreciation of the invention and the many embodiments thereof will be readily obtained as the same becomes better understood by reference to the following detailed description when considered in connection with the accompanying drawings, wherein:

FIG. 1A is a front perspective view of the wall-mounted charging device and modular outlet extender of the present invention suitable for use in North America;

FIG. 1B is a rear perspective view of the wall-mounted charging device and modular outlet extender of the present invention suitable for use in North America;

FIG. 1C is a front plan view of the wall-mounted charging device and modular outlet extender of the present invention suitable for use in North America;

FIG. 1D is a rear plan view of the wall-mounted charging device and modular outlet extender of the present invention suitable for use in North America;

FIG. 1E is a top plan view of the wall-mounted charging device and modular outlet extender of the present invention suitable for use in North America;

FIG. 1F is a bottom plan view of the wall-mounted charging device and modular outlet extender of the present invention suitable for use in North America;

FIG. 1G is a front perspective view of the wall-mounted charging device and modular outlet extender of the present invention in a stacked configuration suitable for use in North America;

FIG. 2A is a front perspective view of a single outlet wall-mounted charging device and modular outlet extender of the present invention suitable for use in Western Europe, specifically the United Kingdom;

FIG. 2B is a rear perspective view of a single outlet wall-mounted charging device and modular outlet extender of the present invention suitable for use in Western Europe, specifically the United Kingdom;

FIG. 2C is a front perspective view of a dual outlet wall-mounted charging device and modular outlet extender of the present invention suitable for use in Western Europe, specifically the United Kingdom;

FIG. 2D is a rear perspective view of a dual outlet wall-mounted charging device and modular outlet extender of the present invention suitable for use in Western Europe, specifically the United Kingdom;

FIG. 2E is a bottom plan view of the wall-mounted charging device and modular outlet extender of the present invention suitable for use in Western Europe, specifically the United Kingdom;

FIG. 3A is a front perspective view of a single outlet wall-mounted charging device and modular outlet extender of the present invention suitable for use in Western Europe, specifically in Germany;

FIG. 3B is a rear perspective view of a single outlet wall-mounted charging device and modular outlet extender of the present invention suitable for use in Western Europe, specifically in Germany;

FIG. 3C is a top plan view of an alternate embodiment of a single outlet wall-mounted charging device and modular outlet extender of the present invention suitable for use in Western Europe, specifically in Germany;

FIG. 4A is a front perspective view of a single outlet wall-mounted charging device and modular outlet extender of the present invention suitable for use in Western Europe, specifically in France;

FIG. 4B is a rear perspective view of a single outlet wall-mounted charging device and modular outlet extender of the present invention suitable for use in Western Europe, specifically in France;

FIG. 4C is a bottom plan view of the wall-mounted charging device and modular outlet extender of the present invention suitable for use in Western Europe, specifically in France;

FIG. 5A is a front perspective view of a single outlet wall-mounted charging device and modular outlet extender of the present invention suitable for use in Asia, specifically in China;

FIG. 5B is a rear perspective view of a single outlet wall-mounted charging device and modular outlet extender of the present invention suitable for use in Asia, specifically in China;

FIG. 5C is a bottom plan view of the wall-mounted charging device and modular outlet extender of the present invention suitable for use in Asia, specifically in China;

FIG. 6A is a front plan view of a micro USB insert, suitable for use in the present invention.

FIG. 6B is a front plan view of an Apple Lightening insert, suitable for use in the present invention.

FIG. 6C is a front plan view of an Apple 30 pin insert, suitable for use in the present invention.

FIG. 7A is a front perspective view of an insert retainer, with the insert installed, suitable for use in the present invention.

FIG. 7B is a front perspective view of an insert retainer, with the insert released, suitable for use in the present invention.

FIG. 7C is a front plan view of the present invention wall-mounted charging device with schematic electrical components shown within the body of the charging device.

### DETAILED DESCRIPTION AND PREFERRED

### Embodiments of the Invention

The wall mounted charging device of the present invention enables a charging station to be provided on a wall outlet without obstructing the receptacle of the outlet. The charging device of the present invention provides a utilitarian and aesthetically pleasing solution to the issue of blocked receptacles, wire tangles and unsightly wall mounted chargers. The charging device of the present invention may be doubled up to provide two or more charging stations. The device also is available with multiple charging tips to provide flexibility in charging devices of different generations and different manufacturers, essentially any rechargeable device may be installed on the wall charger with a suitable charging tip installed.

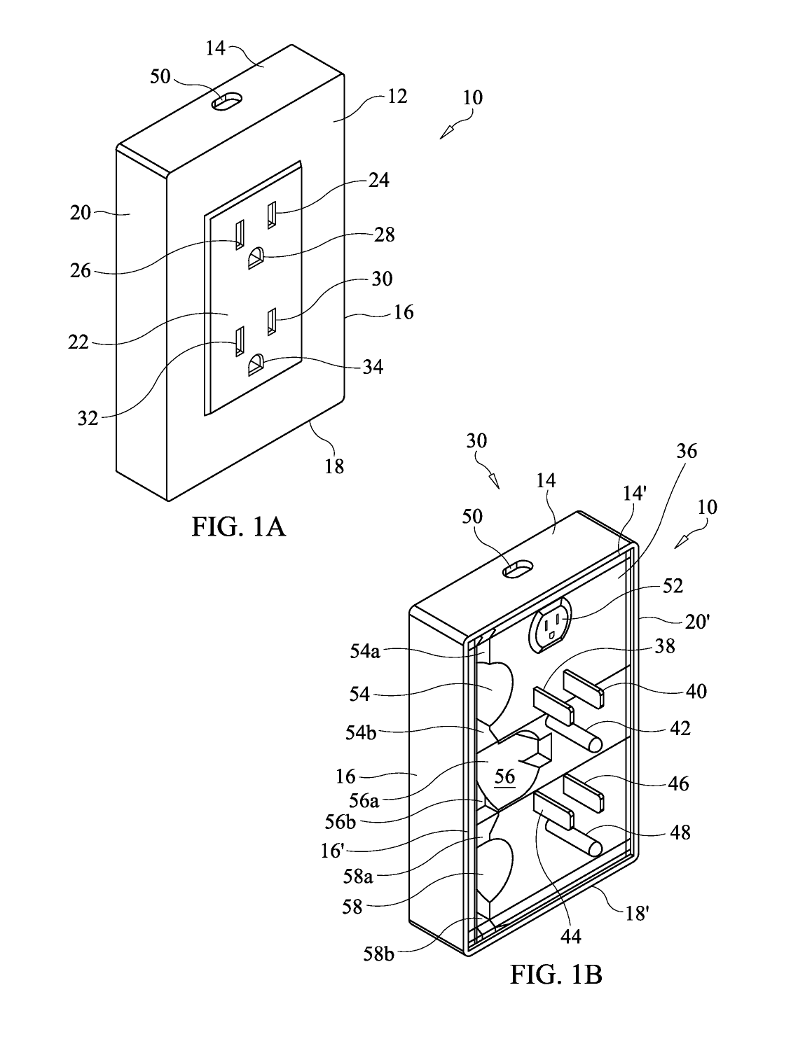

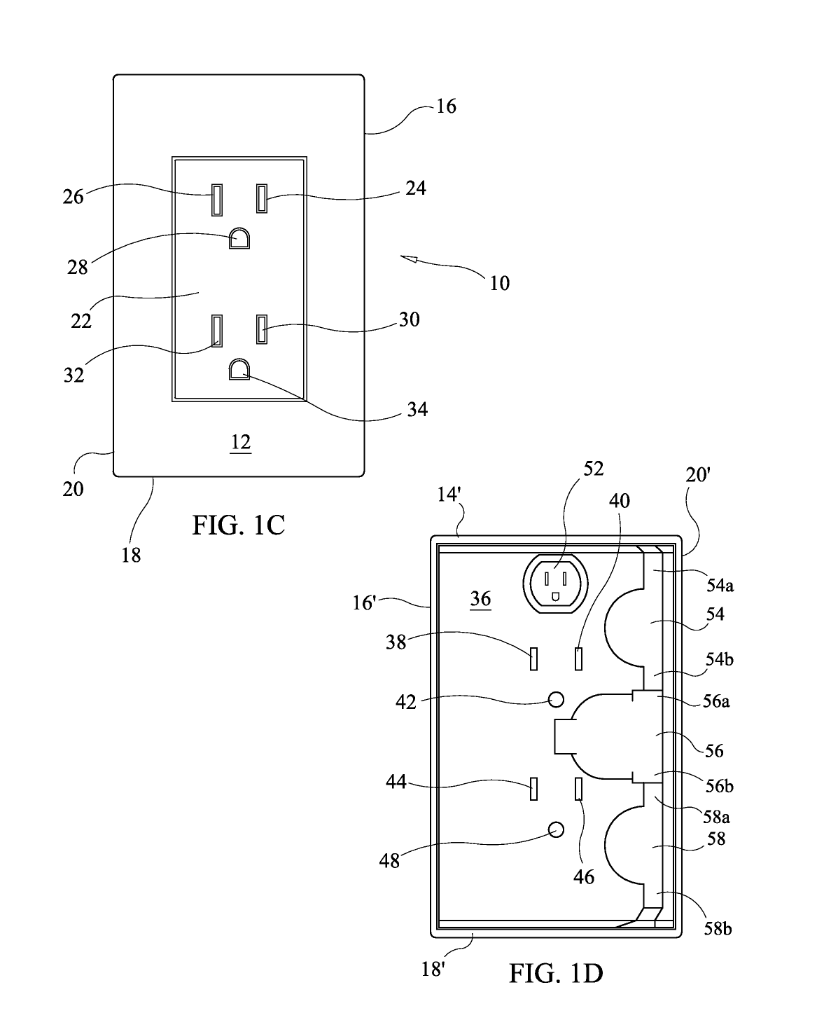

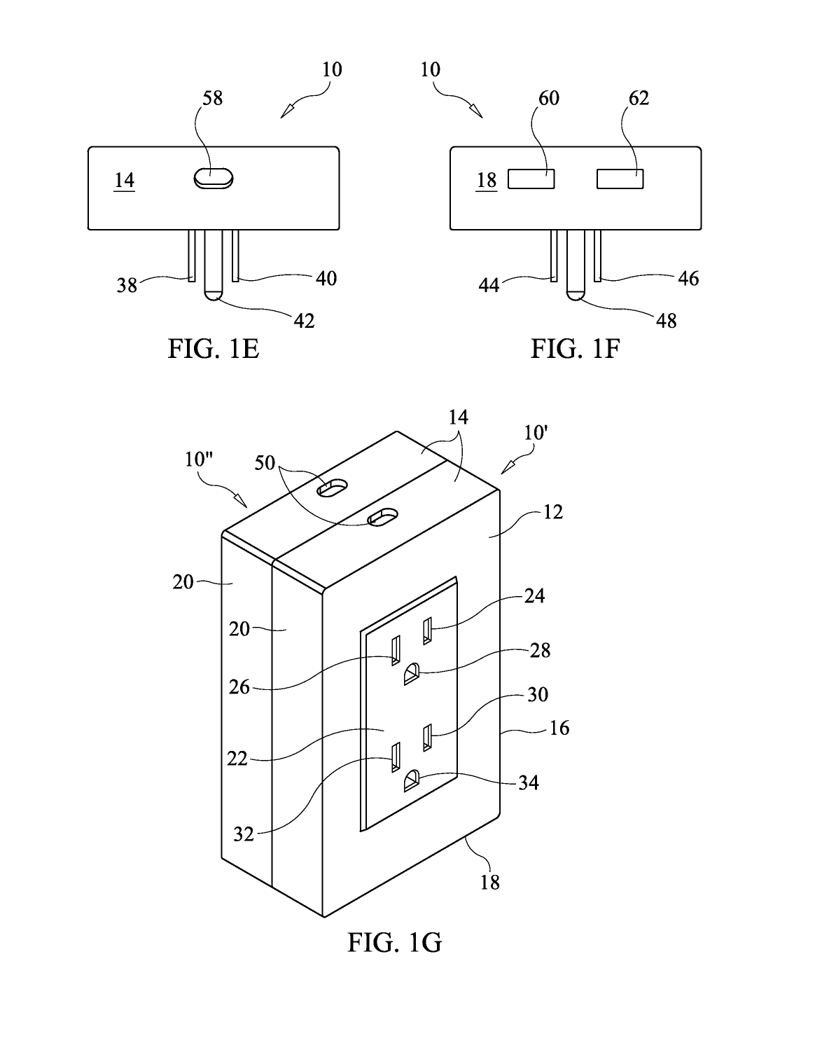

FIG. 1A shows a wall-mounted charging device and modular outlet extender of the present invention in which the charging device 10 includes a front face 12, a top wall 14, a right side wall 16 (not shown), a bottom wall 18 (not shown), and a left side wall 20. Front face 12 includes an outlet plate 22 that includes two outlets with 120V AC “hot” receptacle 24, 30, neutral receptacle 26, 32 and ground receptacle 28, 34. In top wall 14, a receptacle 50 is formed for receiving any of a number of charging tips suitable for use with various electronic components. The 120V AC and receptacle configuration shown is typically suitable for use in North America. Charging device 10 is mounted to a wall outlet and protrudes from the wall by a minimal distance. Receptacle 50, with a charging tip installed forms a charging dock that allows an electronic device to be placed atop charging device 10 so that the device is charged in a convenient location without obstructing the outlets on outlet plate 22.

FIG. 1B shows the rear of the wall-mounted charging device and modular outlet extender of the present invention suitable in which the charging device 10 includes a rear face 36, a top wall 14 having a rear lip 14′, a right side wall 16 having a rear lip 16′, a bottom wall 18 (not shown) having a rear lip 18′, and a left side wall 20 (not shown) having a rear lip 20′. Rear face 36 includes two sets of prongs, specifically 120V AC “hot” prong 38, 44, neutral prong 40, 46 and ground prong 42, 48. Receptacle 50 is formed in top wall 14 for receiving any of a number of charging tips suitable for use with various electronic components. Button 52 disengages the charging tip such that the tip may be changed when a different device is to be charged. A number of receptacles 54, 56, 58 may be formed in back wall 36 to receive the charging tips when not in use. Generally, each receptacle 54, 56, 58 will include a top surface 54a, 56a, 58a and a bottom surface 54b, 56b, 58b that are spaced to receive a specific tip in a friction fit. The rear lips 14′, 16′, 18′, 20′ of sidewalls 14, 16, 18, 20 are adjacent the front face of the wall outlet when installed directly to a wall outlet or may be adjacent the front face 12 of device 10 when installed in a stacked configuration. Device 10 is easily installed in a wall outlet or onto another device 10 by inserting the prongs 38, 40, 42, 44, 46, 48 of device to into the outlet or adjacent device 10. The device may be easily removed and transported or may remain semi-permanently installed in a single location.

FIG. 1C shows the front the wall-mounted charging device and modular outlet extender in which the charging device 10 includes a front face 12, a top wall 14, a right side wall 16, a bottom wall 18, and a left side wall 20. Front face 12 includes an outlet plate 22 that includes two outlets with 120V AC “hot” receptacle 24, 30, neutral receptacle 26, 32 and ground receptacle 28, 34. In top wall 14, a receptacle 50 is formed for receiving any of a number of charging tips suitable for use with various electronic components.

FIG. 1D shows the rear of the wall-mounted charging device and modular outlet extender the charging device 10 including rear face 36, top wall 14 (not shown) having rear lip 14′, right side wall 16 (not shown) having a rear lip 16′, bottom wall 18 (not shown) having a rear lip 18′, and a left side wall 20 (not shown) having a rear lip 20′. Rear face 12 includes two sets of prongs, 120V AC “hot” prong 38, 44, neutral prong 40, 46 and ground prong 42, 48. Button 52 disengages the charging tip such that the tip may be changed when a different device is to be charged. A number of receptacles 54, 56, 58 may be formed in back wall 36 to receive the charging tips when not in use. Generally, each receptacle 54, 56, 58 will include a top surface 54a, 56a, 58a and a bottom surface 54b, 56b, 58b that are spaced to receive a specific tip in a friction fit. The rear lips 14′, 16′, 18′, 20′ of the sidewalls are adjacent the front face of the wall outlet when installed directly to a wall outlet or may be adjacent the front face 12 of device 10 when installed in a stacked configuration.

FIG. 1E shows the top view of the wall-mounted charging device and modular outlet extender including top wall 14 charge tip receptacle 50 as well as 120V AC “hot” prong 38; neutral prong 40; and ground prong 42.

FIG. 1F shows the bottom view of the wall-mounted charging device and modular outlet extender including bottom wall 14 charging ports 60, 62 as well as 120V AC “hot” prong 44; neutral prong 46; and ground prong 48. Charging ports 60, 62 will generally be standard USB ports although any other port including mini-USB and micro-USB ports or any other charging port may be included.

FIG. 1G is a front perspective view of the wall-mounted charging device and modular outlet extender in a stacked configuration. The stack includes a first device 10″ that may be inserted into a wall showing top wall 14 and receptacle 50 and sidewall 20. A second charging location may be provided by installing a second wall-mounted charging device and modular outlet extender into the receptacle of the first device. The second charging device 10′ includes a front face 12, a top wall 14, a right side wall 16 (not shown), a bottom wall 18 (not shown), and a left sidewall 20. Front face 12 includes an outlet plate 22 that includes two outlets with 120V AC “hot” receptacle 24, 30, neutral receptacle 26, 32 and ground receptacle 28, 34. In top wall 14, a receptacle 50 is formed for receiving any of a number of charging tips suitable for use with various electronic components. The 120V AC and receptacle configuration shown is typically suitable for use in North America. Charging device 10 is mounted to a wall outlet and protrudes from the wall by a minimal distance. Receptacle 50, with a charging tip installed forms a charging dock that allows an electronic device to be placed atop charging device 10 so that the device is charged in a convenient location without obstructing the outlets on outlet plate 22.

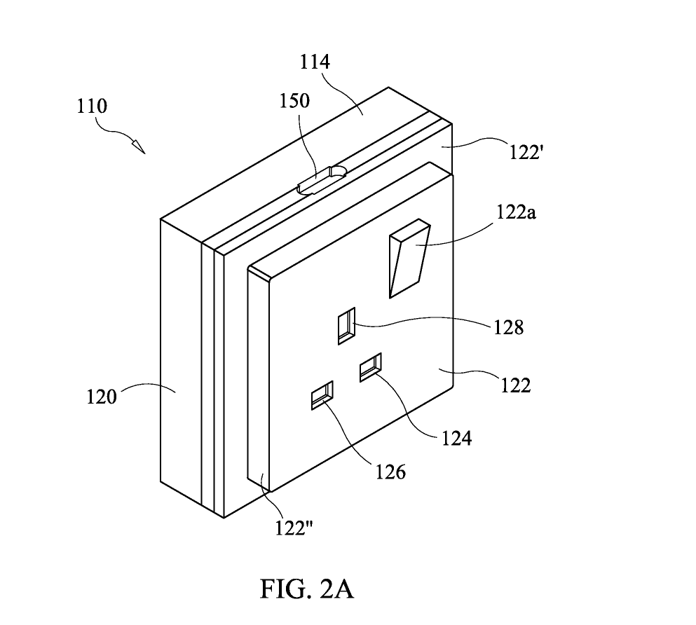

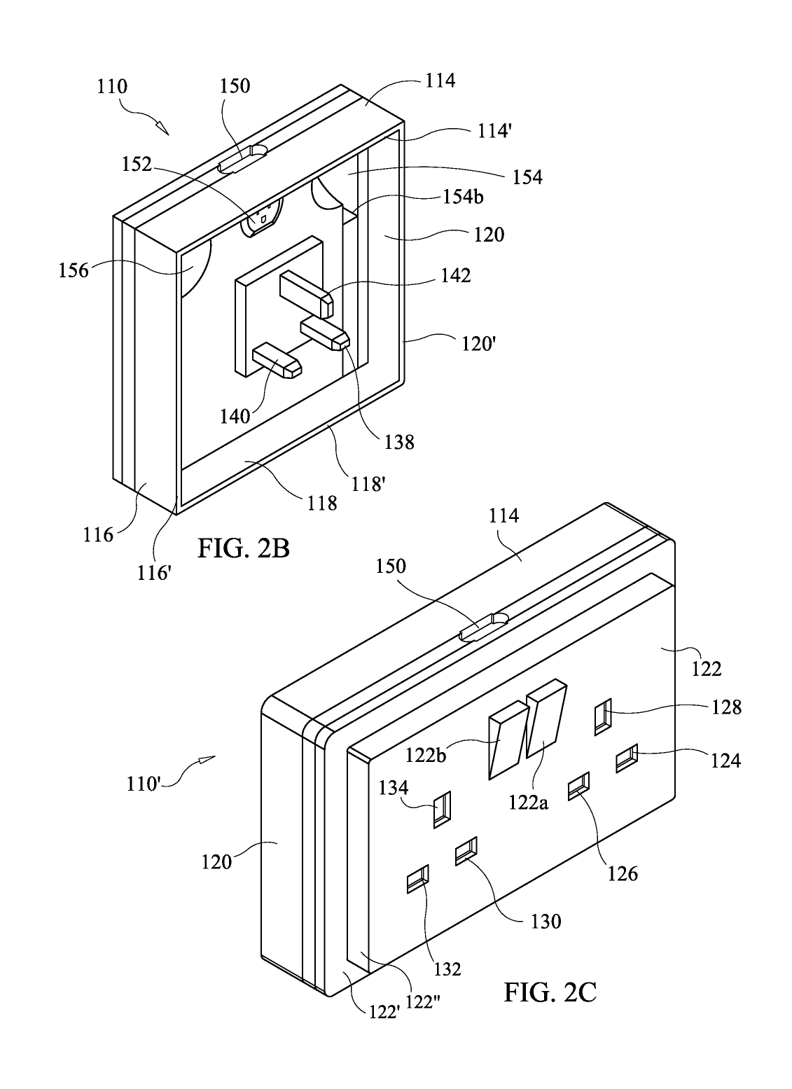

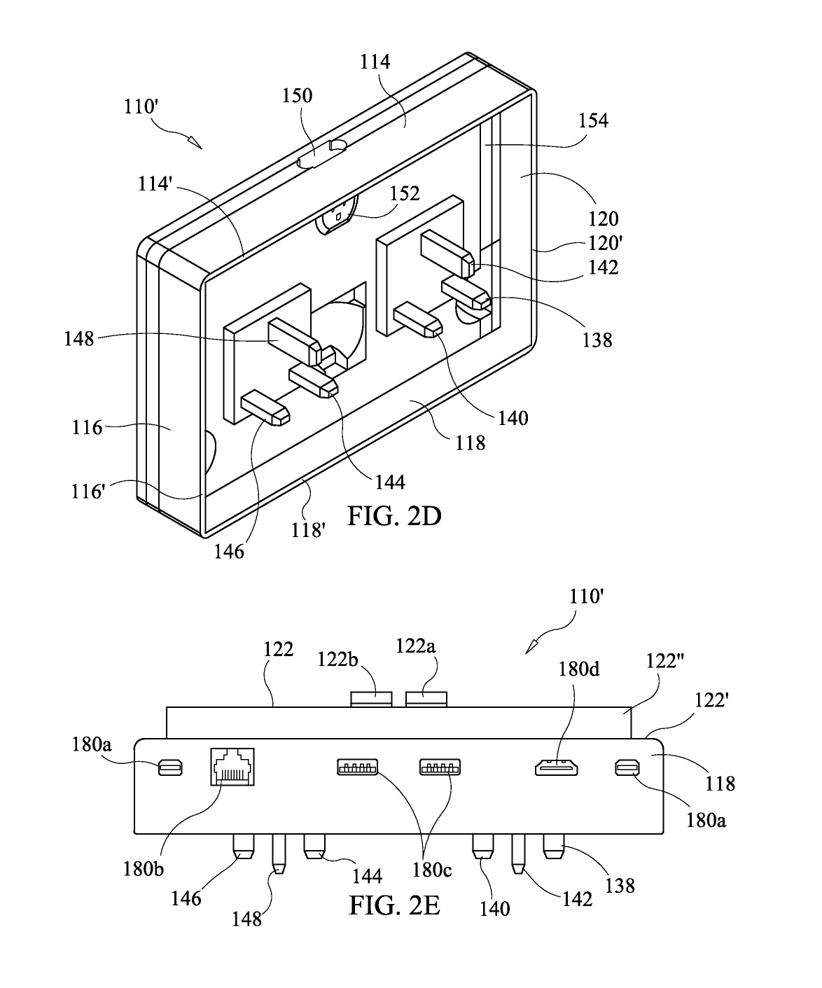

FIG. 2A is a front perspective view of a single outlet wall-mounted charging device and modular outlet extender of the present invention suitable for use in Western Europe, specifically the United Kingdom, which shows a wall-mounted charging device and modular outlet extender of the present invention in which the charging device 110 includes a front face 122, a top wall 114, a right side wall 116 (not shown), a bottom wall 18 (not shown), and a left side wall 120. Front face 122 is raised from the plane of sidewalls 114, 116, 118, 120 that end at surface 122′ by upright wall 122″. Front face 122 includes an outlet with 230V AC “hot” receptacle 124, neutral receptacle 126, and ground receptacle 128. In top wall 114, a receptacle 150 is formed for receiving any of a number of charging tips suitable for use with various electronic components. Front face 122 also includes a control switch 122c that turns off power to the receptacles 124, 126, 130. The 230V AC and receptacle configuration shown is typically suitable for use in the UK. Charging device 110 is mounted to a wall outlet and protrudes from the wall by a minimal distance. Receptacle 150, with a charging tip installed forms a charging dock that allows an electronic device to be placed atop charging device 110 so that the device is charged in a convenient location without obstructing the outlets on front face 122.

FIG. 2B shows the rear of the wall-mounted charging device and modular outlet extender of the present invention suitable for use in the UK in which the charging device 110 includes a top wall 114 having a rear lip 114′, a right side wall 116 having a rear lip 116′, a bottom wall 118 having a rear lip 118′, and a left side wall 120 having a rear lip 120′. Rear face includes 230V AC “hot” prong 138; neutral prong 140 and ground prong 142. Receptacle 150 is formed in top wall 114 for receiving any of a number of charging tips suitable for use with various electronic components. Button 152 disengages the charging tip such that the tip may be changed when a different device is to be charged. A number of receptacles 154, 156 may be formed in back wall to receive the charging tips when not in use. Generally, each receptacle 154, 156 will include a top surface and a bottom surface 154b is shown that are spaced to receive a specific tip in a friction fit. The rear lips 114′, 116′, 118′, 120′ of sidewalls 114, 116, 118, 120 are adjacent the front face of the wall outlet when installed directly to a wall outlet or may be adjacent the front face 112 of device 110 when installed in a stacked configuration. Device 110 is easily installed in a wall outlet or onto another device 110 by inserting the prongs 138, 140, 142 of device 110 to into an outlet or an adjacent device 110. The device may be easily removed and transported or may remain semi-permanently installed in a single location.

FIG. 2C is a front perspective view of a dual outlet wall-mounted charging device and modular outlet extender of the present invention suitable for use in Western Europe, specifically the United Kingdom; which shows a wall-mounted charging device and modular outlet extender of the present invention in which the charging device 110′ includes a front face 122, a top wall 114, a right side wall 116 (not shown), a bottom wall 118 (not shown), and a left side wall 120. Front face 122 is raised from the plane of sidewalls 114, 116, 118, 120 that end at surface 122′ by upright wall 122″. Front face 122 includes two outlets with 230V AC “hot” receptacle 124, 130, neutral receptacle 126, 132, and ground receptacle 128, 134. Front face 122 also includes control switches 122b, 122c that turn off power to the receptacles. In top wall 114, a receptacle 150 is formed for receiving any of a number of charging tips suitable for use with various electronic components. The 230V AC and receptacle configuration shown is typically suitable for use in the UK. Charging device 110′ is mounted to a wall outlet and protrudes from the wall by a minimal distance. Receptacle 150, with a charging tip installed forms a charging dock that allows an electronic device to be placed atop charging device 110′ so that the device is charged in a convenient location without obstructing the outlets on front face 122.

FIG. 2D is a rear perspective view of a dual outlet wall-mounted charging device and modular outlet extender 110′ of the present invention suitable for use in Western Europe, specifically the United Kingdom; which shows the rear of the wall-mounted charging device and modular outlet extender of the present invention suitable for use in the UK in which the charging device 110′ includes a top wall 114 having a rear lip 114′, a right side wall 116 having a rear lip 116′, a bottom wall 118 having a rear lip 118′, and a left side wall 120 having a rear lip 120′. Rear face includes 230V AC “hot” prong 138, 144, neutral prong 140, 146 and ground prong 142, 148. Receptacle 150 is formed in top wall 114 for receiving any of a number of charging tips suitable for use with various electronic components. Button 152 disengages the charging tip such that the tip may be changed when a different device is to be charged. A number of receptacles 154, 156 may be formed in back wall to receive the charging tips when not in use. Generally, each receptacle 154, 156 will include a top surface and a bottom surface that are spaced to receive a specific tip in a friction fit. The rear lips 114′, 116′, 118′, 120′ of sidewalls 114, 116, 118, 120 are adjacent the front face of the wall outlet when installed directly to a wall outlet or may be adjacent the front face 122 of device 110 when installed in a stacked configuration. Device 110′ is easily installed in a wall outlet or onto another device 110′ by inserting the prongs 138, 140, 142 and 144, 146, 148 of device 110′ to into an outlet or an adjacent device 110′. The device may be easily removed and transported or may remain semi-permanently installed in a single location.

FIG. 2E is a bottom plan view of a dual outlet wall-mounted charging device 110′ and modular outlet extender of the present invention suitable for use in Western Europe, specifically the United Kingdom; which shows the bottom view of the wall-mounted charging device and modular outlet extender including bottom wall 118 as well as “hot” prong 138, 144, neutral prong 140, 146; and ground prong 142, 148. Front face 122 is raised from surface 122′ by upright wall 122″. Front face 122 includes two outlets (not shown) and control switches 122b, 122c that turn off power to the outlets. Ports 180a, 180b, 180c, and 180d may be standard USB ports mini-USB and micro-USB ports although any other charging port may be included.

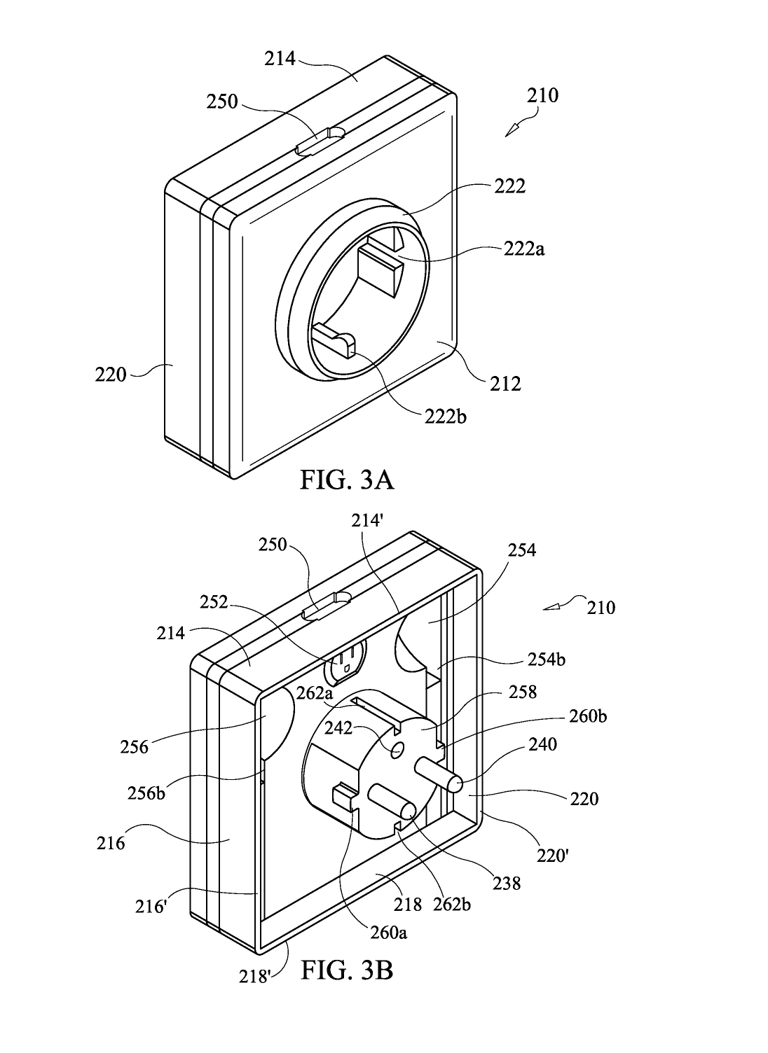

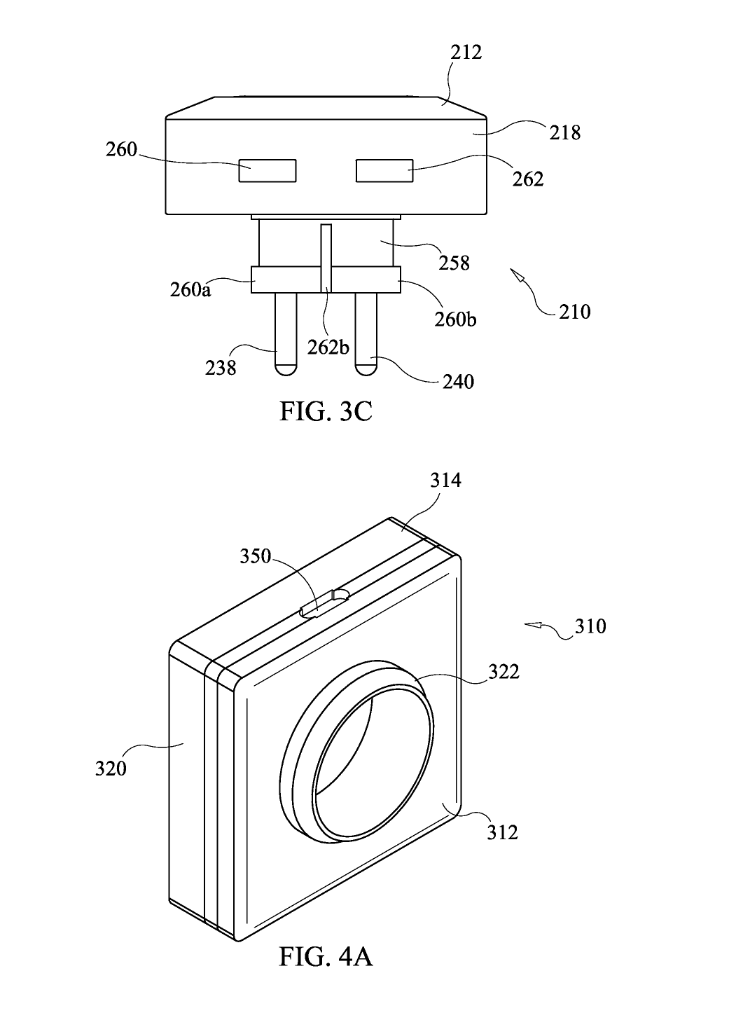

FIG. 3A is a front perspective view of a single outlet wall-mounted charging device and modular outlet extender of the present invention suitable for use in Western Europe, specifically in Germany; which shows a wall-mounted charging device and modular outlet extender of the present invention in which the charging device 210 includes a front face 212, a top wall 214, a right side wall 216 (not shown), a bottom wall 218 (not shown), and a left side wall 220. Front face 212 includes an outlet ring 222 with alignment mechanism 222a and latch 222b. Outlet ring 222 includes an outlet with 230V AC. In top wall 214, a receptacle 250 is formed for receiving any of a number of charging tips suitable for use with various electronic components. The 230V AC and receptacle configuration shown is typically suitable for use in Germany. Charging device 210 is mounted to a wall outlet and protrudes from the wall by a minimal distance. Receptacle 250, with a charging tip installed forms a charging dock that allows an electronic device to be placed atop charging device 210 so that the device is charged in a convenient location without obstructing the outlet 222.

FIG. 3B is a rear perspective view of a single outlet wall-mounted charging device and modular outlet extender of the present invention suitable for use in Western Europe, specifically in Germany; in which the charging device 210 includes a top wall 214 having a rear lip 214′, a right side wall 216 having a rear lip 216′, a bottom wall 218 having a rear lip 218′, and a left side wall 220 having a rear lip 220′. The ear face includes 230V AC “hot” prong 238 and neutral prong 240. Receptacle 250 is formed in top wall 214 for receiving any of a number of charging tips suitable for use with various electronic components. Button 252 disengages the charging tip such that the tip may be changed when a different device is to be charged. A number of receptacles 254, 256 may be formed in back wall to receive the charging tips when not in use. Generally, each receptacle 254, 256 will include a top surface and a bottom surface (254b and 256b are shown) that are spaced to receive a specific tip in a friction fit. The rear lips 214′, 216′, 218′, 220′ of sidewalls 214, 216, 218, 220 are adjacent the front face of the wall outlet when installed directly to a wall outlet or may be adjacent the front face 212 of device 210 when installed in a stacked configuration. Device 210 is easily installed in a wall outlet or onto another device 210 by inserting the prongs 238, 240 of device 210 to into an outlet or an adjacent device 210. The device may be easily removed and transported or may remain semi-permanently installed in a single location.

FIG. 3C is a bottom plan view of the wall-mounted charging device and modular outlet extender of the present invention suitable for use in Western Europe, specifically in Germany. The wall-mounted charging device and modular outlet extender 210 includes bottom wall 218 charging ports 260, 262 as well as “hot” prong 238 and neutral prong 240. Charging ports 260, 262 may be standard USB ports mini-USB and micro-USB ports although any other charging port may be included. Front face 212 includes an outlet port with may receive prongs 238, 240 as well as latch collars 260a, 260b, alignment post 262b and ring 258 when stacked with a second charging device 210 or is left free to receive a cord from a standard electrical appliance.

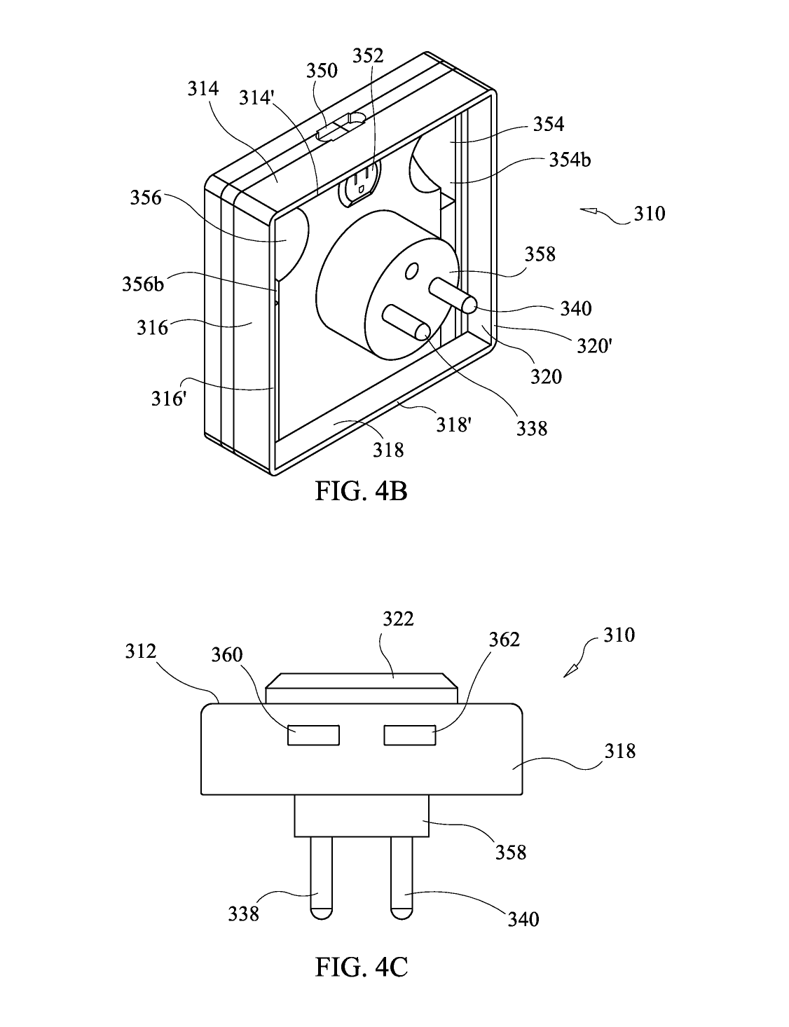

FIG. 4A is a front perspective view of a single outlet wall-mounted charging device and modular outlet extender of the present invention suitable for use in Western Europe, specifically in France; which shows a wall-mounted charging device and modular outlet extender of the present invention in which the charging device 310 includes a front face 312, a top wall 314, a right side wall 316 (not shown), a bottom wall 318 (not shown), and a left side wall 320. Front face 312 includes an outlet ring 322. Outlet ring 322 includes an outlet with 230V AC. In top wall 314, a receptacle 350 is formed for receiving any of a number of charging tips suitable for use with various electronic components. The 230V AC and receptacle configuration shown is typically suitable for use in France. Charging device 310 is mounted to a wall outlet and protrudes from the wall by a minimal distance. Receptacle 350, with a charging tip installed forms a charging dock that allows an electronic device to be placed atop charging device 310 so that the device is charged in a convenient location without obstructing the outlet 322.

FIG. 4B is a rear perspective view of a single outlet wall-mounted charging device and modular outlet extender of the present invention suitable for use in Western Europe, specifically in France; in which the charging device 310 includes a top wall 314 having a rear lip 314′, a right side wall 316 having a rear lip 316′, a bottom wall 318 having a rear lip 318′, and a left side wall 320 having a rear lip 320′. Rear face includes 230V AC “hot” prong 338 and neutral prong 340. Receptacle 350 is formed in top wall 314 for receiving any of a number of charging tips suitable for use with various electronic components. Button 352 disengages the charging tip such that the tip may be changed when a different device is to be charged. A number of receptacles 354, 356 may be formed in the back wall to receive the charging tips when not in use. Generally, each receptacle 354, 356 will include a top surface and a bottom surface (bottom surfaces 354b, 356b are shown), which are spaced to receive a specific tip in a friction fit. The rear lips 314′, 316′, 318′, 320′ of sidewalls 314, 316, 318, 320 are adjacent the front face of the wall outlet when installed directly to a wall outlet or may be adjacent the front face 312 of device 310 when installed in a stacked configuration. Device 310 is easily installed in a wall outlet or onto another device 310 by inserting the prongs 338, 340, of device 310 into an outlet or an adjacent device 310. The device may be easily removed and transported or may remain semi-permanently installed in a single location.

FIG. 4C is a bottom plan view of the wall-mounted charging device and modular outlet extender of the present invention suitable for use in Western Europe, specifically in France; which shows bottom wall 318 charging ports 360, 362 as well as “hot” prong 338 and neutral prong 340. Front face 312 includes outlet ring 322. Bottom wall 318 may include charging ports 360, 362, which may be standard USB ports mini-USB and micro-USB ports although any other charging port may be included.

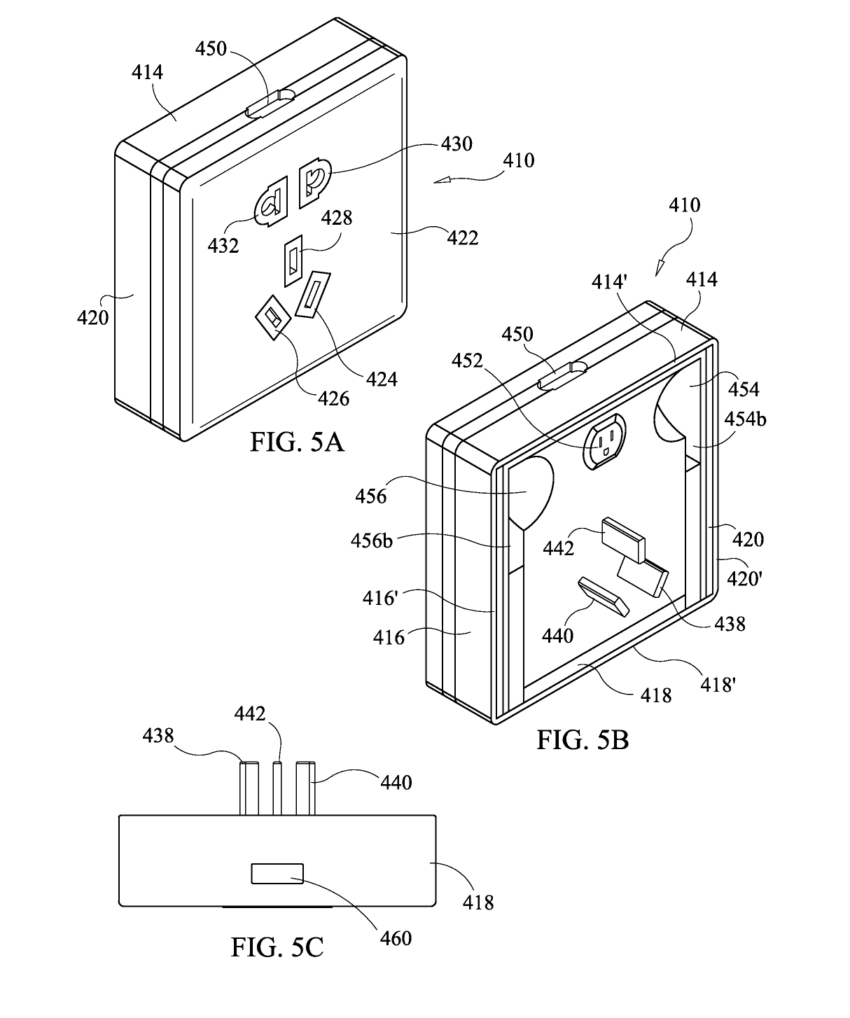

FIG. 5A is a front perspective view of a single outlet wall-mounted charging device and modular outlet extender of the present invention suitable for use in Asia, specifically in China; which shows a wall-mounted charging device and modular outlet extender of the present invention in which the charging device 410 includes a front face 422, a top wall 414, a right side wall 416 (not shown), a bottom wall 418 (not shown), and a left side wall 420. Front face 422 includes two outlets with 220-230V AC “hot” each with receptacles 424, 430, neutral receptacles 426, 432, and ground receptacle 428. In top wall 414, a receptacle 450 is formed for receiving any of a number of charging tips suitable for use with various electronic components. Charging device 410 is mounted to a wall outlet and protrudes from the wall by a minimal distance. Receptacle 450, with a charging tip installed forms a charging dock that allows an electronic device to be placed atop charging device 410 so that the device is charged in a convenient location without obstructing the outlets on front face 422.

FIG. 5B is a rear perspective view of a single outlet wall-mounted charging device and modular outlet extender of the present invention suitable for use in Asia, specifically in China; in which the charging device 410 includes a top wall 414 having a rear lip 414′, a right side wall 416 having a rear lip 416′, a bottom wall 418 having a rear lip 418′, and a left side wall 420 having a rear lip 420′. Rear face includes 230V AC “hot” prong 438; neutral prong 440 and ground prong 442. Receptacle 450 is formed in top wall 414 for receiving any of a number of charging tips suitable for use with various electronic components. Button 452 disengages the charging tip such that the tip may be changed when a different device is to be charged. A number of receptacles 454, 456 may be formed in back wall to receive the charging tips when not in use. Generally, each receptacle 454, 456 will include a top surface and a bottom surface (although only lower surfaces 454b 456b are shown) that are spaced to receive a specific tip in a friction fit. The rear wall lips 414′, 416′, 418′, 420′ of sidewalls 414, 416, 418, 420 are adjacent the front face of the wall outlet when installed directly to a wall outlet or may be adjacent the front face 422 of a second device 410 when installed in a stacked configuration. Device 410 is easily installed in a wall outlet or onto another device 410 by inserting the prongs 438, 440, 442 of device 410 to into an outlet or an adjacent device 410. The device may be easily removed and transported or may remain semi-permanently installed in a single location.

FIG. 5C is a bottom plan view of the wall-mounted charging device and modular outlet extender of the present invention suitable for use in Asia, specifically in China; which shows the bottom view of the wall-mounted charging device and modular outlet extender 410 including bottom wall 418 charging port 460 as well as “hot” prong 438, neutral prong 440 and ground prong 442. One or more charging ports 460 may be standard USB ports mini-USB and micro-USB ports although any other charging port may be included.

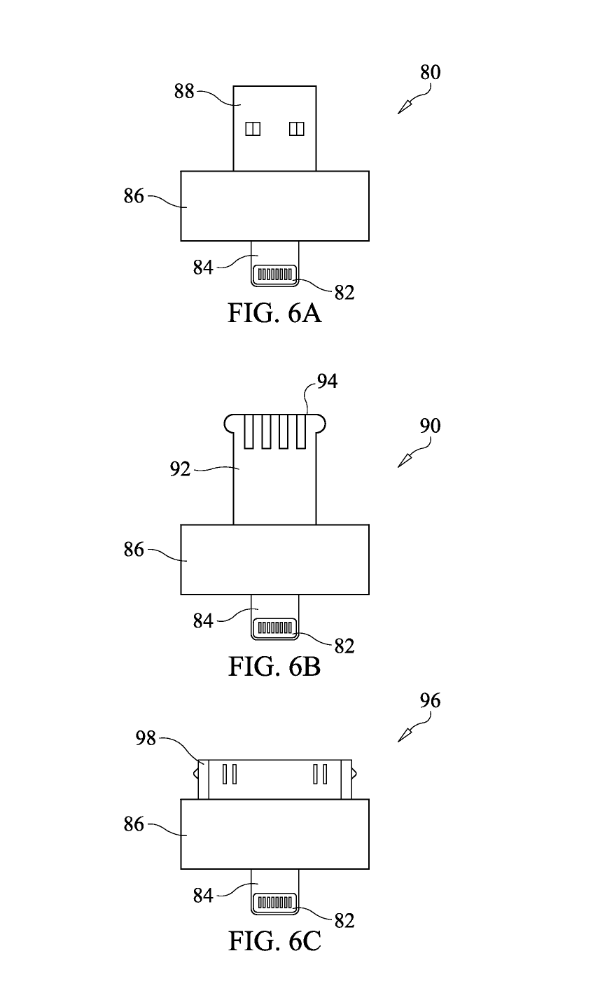

FIG. 6A is a front plan view of a micro USB type insert 80, showing USB compatible tip 88, reinforcement collar 86, and insert 84 with electrical connections 82. Insert 80 may be installed in any of the receptacles 50, 150, 250, 350, 450 discussed above to provide a micro USB compatible charge in any country.

FIG. 6B is a front plan view of an Apple Lightening type insert 90, suitable for use in the present invention, showing Apple Lightening compatible tip 92, with exposed electrical connections 94, reinforcement collar 86, and insert 84 with electrical connections 82. Insert 90 may be installed in any of the receptacle 50, 150, 250, 350, 450 discussed above to provide an Apple Lightening compatible charge in any country.

FIG. 6C is a front plan view of an Apple 30 pin type insert 96, suitable for use in the present invention, showing an Apple 30 pin compatible tip 98, reinforcement collar 86, and insert 84 with electrical connections 82. Insert 96 may be installed in any of the receptacle 50, 150, 250, 350, 450 discussed above to provide a micro USB compatible charge in any country.

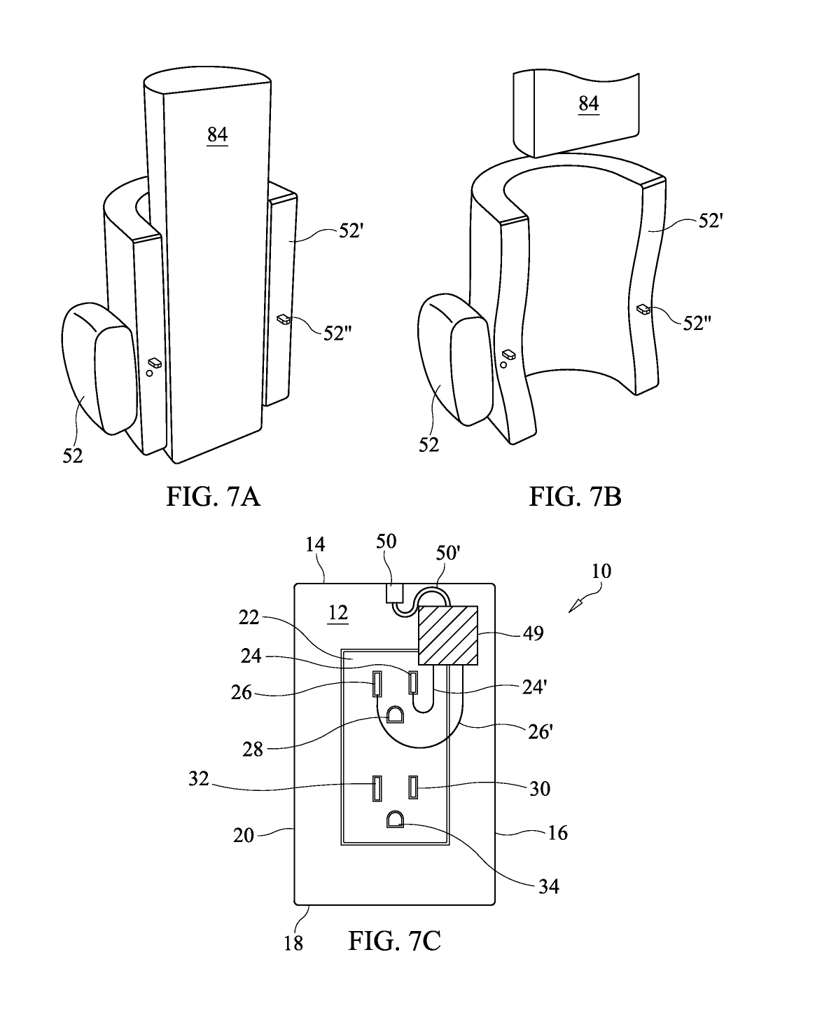

FIG. 7A is a front perspective view of an insert retainer, with the insert 84 installed, in which button 50 is in contact with flexible tube 52. The flexible tube 52 may include a spring 52′ which biases the tube out of a cylindrical shape such that the bias retains insert 84 in a flexible friction fit within tube 50. The flexibility of tube 52 serves to reduce stress on the charging tip 80, 90, 96, as well as the electrical device installed thereon. Any number of connections may be used in securing charging tips 80, 90, 96, including; a ratchet and pawl configuration, a friction fit connection, one or more ridges formed on tips 80, 90, 96 that mechanically interlock within the device.

FIG. 7B is a front perspective view of an insert retainer, with the insert 84 released, suitable for use in the present invention. Button 50 is in contact with flexible tube 52. The flexible tube 52 may include a spring 52′ which biases the tube out of a cylindrical shape such that the bias retains insert 84 in a flexible friction fit within tube 52. When button 50 is depressed, tube 52 is returned to a substantially cylindrical shape such that insert 84 may be installed.

FIG. 7C is a front plan view of the present invention wall-mounted charging device with schematic electrical components shown within the body of the charging device. which the charging device 10 includes a front face 12, a top wall 14, a right side wall 16, a bottom wall 18 and a left side wall 20. Front face 12 includes an outlet plate 22 that includes two outlets with 120V AC “hot” receptacle 24, 30, neutral receptacle 26, 32 and ground receptacle 28, 34. In top wall 14, a receptacle 50 is formed for receiving any of a number of charging tips suitable for use with various electronic components. The 120V AC and receptacle configuration shown is typically suitable for use in North America although the outlet configuration and voltage requirements may be configured for the power standards of any region. Leads 24′, 26′ connect receptacles 24, 26 to a power adapter 49 such as an iWatt iW1691-03 Adapter having an AC input of 90-264 VAC and an output of 5V at 2.1AMPs. Any other suitable power adapter may be used. Leads 50′ connect power adaptor 49 to receptacle 50 as well as any other low voltage connections formed in the front face 12, top wall 14, sidewalls 16, 20 or bottom wall 18. The specifications for the iW1691-03 adapter are shown in Table 1 below:

TABLE 1

| | | | | | |
|---|---|---|---|---|---|
| Description | Symbol | Min | Typ | Max | Units |

Input

| | | | | | |
|---|---|---|---|---|---|
| Voltage | V_{IN} | 90 | | 264 | V_{AC} |
| Frequency | f_{LINE} | 47 | 50/60 | 63 | Hz |
| No-load input power | | | | 150 | mW |
| (230 V_{AC}) | | | | | |

Output

| | | | | |
|---|---|---|---|---|
| Output voltage | V_{OUT} | 4.85 | 5.25 | V |
| Output current | I_{OUT} | 0 | 2.1 | A |
| Output ripple voltage | V_{RIPPLE} | | 100 | mV_{P}_{_{—}}_{P} |

Total Output Power

| | | | | | |
|---|---|---|---|---|---|
| Continuous output power | P_{OUT} | | 10.5 | | W |
| Over-current protection | I_{OUT MAX} | | | 2.5 | A |
| Active mode protection | η | 80 | | | % |

While the power adapter chip 49 is preferably an adapter, any of a ground fault interrupter, a surge protector, a mechanical power interruption switch, or a WiFi extender may be included. The power supply may also be connected to a remote control unit, thunderbolt, USB, Micro USB, HDMI, Ethernet connector formed in one of the walls.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

I claim:

1. A charging device configured to be engaged with an electrical receptacle, comprising:
one or more low-voltage charging ports and one or more high-voltage electrical sockets, such that when the charging device is engaged with the receptacle, at least one of the charging ports and at least one of the high voltage electrical sockets are accessible for use and wherein at least one charging port is configured to engage a charging connector or charging cable of an electronic component to be charged; and
a support for the electronic component to be charged.

2. The charging device according to claim 1 wherein at least one charging port is configured to receive an adapter configured to engage the charging connector or charging cable of the electronic component to be charged.

3. A charging device according to claim 1 further comprising a front surface that is facing away from the receptacle and a rear surface that is facing toward the receptacle wherein one or more of the electrical sockets are located on the front surface and one or more electrical plugs are extending from the rear surface.

4. A charging device according to claim 3 further comprising a peripheral surface wherein at least one of the charging ports is formed on the peripheral surface.

5. A charging device according to claim 4 wherein at least one charging port is configured to engage a charging connector or charging cable of an electronic component to be charged.

6. A charging device according to claim 4 wherein at least one charging port is configured to receive an adapter configured to engage a charging connector or charging cable of an electronic device to be charged.

7. A charging device according to claim 4 wherein a portion of the peripheral surface faces generally upward and has at least one of the changing ports formed thereon.

8. A charging device according to claim 7 wherein the electronic component being charged is supported on the generally upward facing portion.

9. A charging device configured to be engaged with an electrical receptacle, comprising:
one or more low-voltage charging ports and one or more high-voltage electrical sockets, the charging device configured to connect to a second charging device through at least one of the high-voltage electrical sockets, wherein the second charging device further comprises at least one additional charging port and at least one or more additional high-voltage electrical sockets, such that at least one of the charging ports and at least one of the high-voltage electrical sockets on the second device are accessible for use and wherein at least one charging port or one additional charging port is configured to engage a charging connector or charging cable of an electronic component to be charged and wherein at least one charging port or one additional charging port is configured to receive an adapter configured to engage the charging connector or charging cable of the electronic component to be charged; and
a support for the electronic component to be charged.

10. A charging device according to claim 9 further comprising a front surface that is facing away from the receptacle and a rear surface that is facing toward the receptacle wherein one or more of the electrical sockets are located on the front surface and one or more electrical plugs are extending from the rear surface.

11. A charging device according to claim 10 further comprising a peripheral surface wherein at least one of the charging ports or one of the additional charging port is formed on the peripheral surface.

12. A charging device according to claim 11 wherein at least one charging port or one additional charging port is configured to engage a charging connector or charging cable of an electronic component to be charged.

13. A charging device according to claim 11 wherein at least one charging port or one additional charging port is configured to receive an adapter configured to engage a charging connector or charging cable of an electronic device to be charged.

14. A charging device according to claim 11 wherein a portion of the peripheral surface faces generally upward and has at least one of the changing ports or one of the additional charging ports formed thereon.

15. A charging device according to claim 14 wherein the electronic component being charged is supported on the generally upward facing portion.

16. A wall-mounted charging device and modular outlet extender, comprising:
a housing having a front wall, a top wall, side walls, a bottom wall and a rear wall;
at least one electrical outlet formed in the front wall;
at least one set of electrical connection prongs extending from the rear wall; and
an auxiliary charging port formed on the top wall, wherein the top wall supports an electrical device placed thereon while the device is connected to the auxiliary port for charging.

17. The wall-mounted charging device and modular outlet extender of claim 16, further comprising:
a removable charging tip extending from the auxiliary port

18. The wall-mounted charging device and modular outlet extender of claim 16, further comprising:
a second auxiliary port formed in the bottom wall of housing.

19. The wall-mounted charging device and modular outlet extender of claim 16, further comprising:
a plurality of auxiliary ports formed in the bottom wall of housing.

20. The wall-mounted charging device and modular outlet extender of claim 16, further comprising:
one or more auxiliary ports formed in the sidewalls of housing.

21. The wall-mounted charging device and modular outlet extender of claim 16, further comprising:
a power supply unit providing low voltage power to the auxiliary port in the top wall.

22. The wall-mounted charging device and modular outlet extender of claim 16, further comprising:
a power supply unit providing low voltage power.

23. The wall-mounted charging device and modular outlet extender of claim 16, further comprising:
a ground fault interrupter formed in the housing.

24. The wall-mounted charging device and modular outlet extender of claim 16, further comprising:
a surge protector formed in the housing.

25. The wall-mounted charging device and modular outlet extender of claim 16, further comprising:
a device selected from the group of mechanical power interruption switch WiFi extender, thunderbolt connection, USB connector, Micro USB connector, HDMI connector, Ethernet connector, and other such industry standard connectors, remote control unit or an audio connector.

26. A wall-mounted charging device and modular outlet extender, comprising:
a housing having a front wall, a top wall, side walls, a bottom wall and a rear wall;
at least one electrical outlet formed in the front wall;
at least one set of electrical connection prongs extending from the rear wall; and
an auxiliary charging port formed on the top wall; and
a removable charging tip extending from the auxiliary port, wherein the top wall supports an electrical device placed thereon while the device is connected to the auxiliary port for charging.

27. The wall-mounted charging device and modular outlet extender of claim 26, further comprising:
a second auxiliary port formed in at least one wall of housing.

28. The wall-mounted charging device and modular outlet extender of claim 26, further comprising:
a power supply unit providing low voltage power to the auxiliary port in the top wall.

29. The wall-mounted charging device and modular outlet extender of claim 26, further comprising:
a ground fault interrupter formed in the housing.

30. The wall-mounted charging device and modular outlet extender of claim 26, further comprising:
a surge protector formed in the housing

31. The wall-mounted charging device and modular outlet extender of claim 26, further comprising:
a device selected from the group of mechanical power interruption switch WiFi extender, thunderbolt connection, USB connector, Micro USB connector, HDMI connector, Ethernet connector, and other industry standard connectors, remote control unit or an audio connector.

32. A wall-mounted charging device and modular outlet extender, comprising:
a housing having a front wall, a top wall, side walls, a bottom wall and a rear wall;
at least one electrical outlet formed in the front wall;
at least one set of electrical connection prongs extending from the rear wall;
an auxiliary charging port formed on the top wall;
a power supply unit providing low voltage power to the auxiliary port in the top wall.
a removable charging tip extending from the auxiliary port, wherein the top wall supports an electrical device placed thereon while the device is connected to the auxiliary port for charging; and
a second auxiliary port formed in at least one wall of housing.

33. The wall-mounted charging device and modular outlet extender of claim 32, further comprising:
a ground fault interrupter formed in the housing.

34. The wall-mounted charging device and modular outlet extender of claim 32, further comprising:
a surge protector formed in the housing.

35. The wall-mounted charging device and modular outlet extender of claim 32, further comprising:
a device selected from the group of mechanical power interruption switch WiFi extender, thunderbolt connection, USB connector, Micro USB connector, HDMI connector, Ethernet connector, and other industry standard connectors, remote control unit or an audio connector.
